(19) United States
(12) Patent Application Publication
(10) Pub. No.: US 2025/0272404 A1
(43) Pub. Date: Aug. 28, 2025

(54) FIRMWARE UPDATE APPARATUS AND METHOD FOR UPDATING FIRMWARE

(71) Applicant: LITE-ON TECHNOLOGY CORPORATION, TAIPEI CITY (TW)

(72) Inventors: Chung-Chia KANG, TAIPEI CITY (TW); Ming-Yi LIAO, TAIPEI CITY (TW)

(21) Appl. No.: 18/894,244

(22) Filed: Sep. 24, 2024

Related U.S. Application Data
(60) Provisional application No. 63/557,629, filed on Feb. 26, 2024.
(60) Provisional application No. 63/671,325, filed on Jul. 15, 2024.

(51) Int. Cl. G06F 21/57; G06F 21/60

(52) U.S. Cl. CPC G06F 21/572; G06F 21/602

(57) ABSTRACT

A firmware update apparatus is provided. The firmware update apparatus includes a flash microcontroller, a flash memory, and a receiver. The flash memory has a program memory space, which stores a first formula and a second formula. The receiver is configured to receive a first firmware update file to be stored in the flash memory. The first firmware update file includes a first encrypted firmware file. The flash memory stores one or more target programs configured to be executed by the flash microcontroller. The target programs include instructions for generating a target security key based on the first firmware update file and the first formula, and for decrypting the first firmware update file based on the target security key and the second formula to produce a decrypted firmware file.

### CROSS REFERENCE TO RELATED APPLICATIONS

This application claims priority of U.S. Provisional Application Ser. No. 63/557,629, filed on 2024 Feb. 26, and Provisional Application Ser. No. 63/671,325, filed on 2024 Jul. 15, the entirety of which are incorporated by reference herein.

### BACKGROUND OF THE INVENTION

### Field of the Invention

The present invention relates to updating firmware, and, in particular, to encryption and decryption of an update firmware file.

### Description of the Related Art

Developers may offer updated firmware files to users. For example, a developer may transmit an updated firmware file to the user, or publish the updated firmware file on the Internet and allow the user to download it. For security reasons, the firmware file is encrypted during transmission. Then, after the encrypted firmware file is received, the firmware file is decrypted locally and executed by the receiving device. The encryption and decryption of the firmware file may be based on an encryption key and a decryption key. However, storing an encryption or decryption key in the device may not be secure. Thus, an improved method for updating firmware files and an improved firmware file update apparatus are required.

### BRIEF SUMMARY OF THE INVENTION

An embodiment of the present invention provides a firmware update apparatus, comprising a flash microcontroller, a flash memory, and a receiver. The flash memory has a program memory space, which stores a first formula and a second formula. The receiver is configured to receive a first firmware update file to be stored in the flash memory. The first firmware update file comprises a first encrypted firmware file. The flash memory stores one or more target programs configured to be executed by the flash microcontroller. The target programs include instructions for generating a target security key based on the first firmware update file and the first formula and decrypting the first firmware update file based on the target security key and the second formula to produce a decrypted firmware file.

An embodiment of the present invention provides a method for updating firmware, applicable to a firmware update apparatus. The firmware update apparatus comprises a flash microcontroller and a flash memory with a program memory space. The program memory space stores a first formula and a second formula. The flash memory stores one or more target programs configured to be executed by the flash microcontroller. The method comprises the following steps. A first firmware update file to be stored in the flash memory is received by the receiver of the firmware update apparatus. The first firmware update file comprises the first encrypted firmware file. The flash microcontroller generates a target security key based on the first firmware update file and the first formula. The flash microcontroller then decrypts the first firmware update file based on the target security key and the second formula to produce a decrypted firmware file.

### BRIEF DESCRIPTION OF THE DRAWINGS

The present invention can be more fully understood by reading the subsequent detailed description and examples with references made to the accompanying drawings, wherein:

FIG. 1 is a block diagram of the firmware update apparatus in accordance to the embodiments of the present disclosure;

FIGS. 2A and 2B are flow diagrams of the methods for updating firmware in accordance to the embodiments of the present disclosure;

FIGS. 3A and 3B are flow diagrams of the methods and for updating firmware in accordance to the embodiments of the present disclosure;

FIGS. 4A and 4B are flow diagrams of the methods for updating firmware in accordance to the embodiments of the present disclosure;

FIGS. 5A and 5B are flow diagrams of the methods for updating firmware in accordance to the embodiments of the present disclosure; and

FIG. 6 is a flow diagram of the method for updating firmware in accordance to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

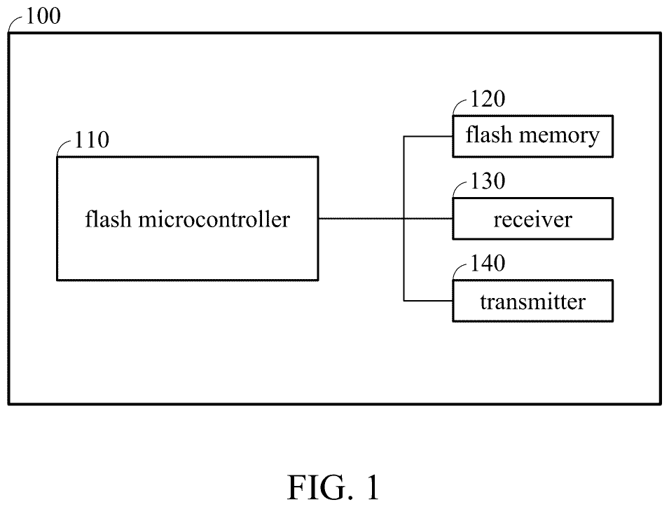

FIG. 1 is a block diagram of the firmware update apparatus 100 in accordance to the embodiments of the present disclosure. The firmware update apparatus 100 comprises a flash microcontroller 110, a flash memory 120, a receiver 130, and a transmitter 140. For example, the firmware update apparatus 100 may be a tablet computer, a notebook computer, a desktop computer, a smartphone, an access point, or a router. The firmware update apparatus 100 may be configured to encrypt a firmware file. The firmware update apparatus 100 may also be configured to decrypt an encrypted firmware file.

The flash microcontroller 110 provides the required process and calculate ability to implement the method of the embodiments. In some embodiments, the flash microcontroller 110 may be implemented in the form of hardware with electronic components, such as transistors, diodes, capacitors, resistors, or inductors. These components are configured and arranged to achieve specific purposes in accordance with the embodiments of the present disclosure.

The flash memory 120 stores data required by the flash microcontroller 110. The flash memory 120 has a program memory space. The program memory space stores a first formula and a second formula. The flash memory 120 also stores one or more target programs including multiple instructions. These target programs may be read and executed by the flash microcontroller 110. When the target programs are executed by the flash microcontroller 110, the instructions cause the flash microcontroller 110 to implement methods of embodiments. In some embodiments, the program memory space is divided into a bootloader section and an application section, and the one or more target programs is executed on (and stored in) the bootloader section.

The receiver 130 and the transmitter 140 are configured to receive and transmit signal or data wirelessly. In some embodiments, the receiver 130 and the transmitter 140 comprises at least one antenna for wireless communication.

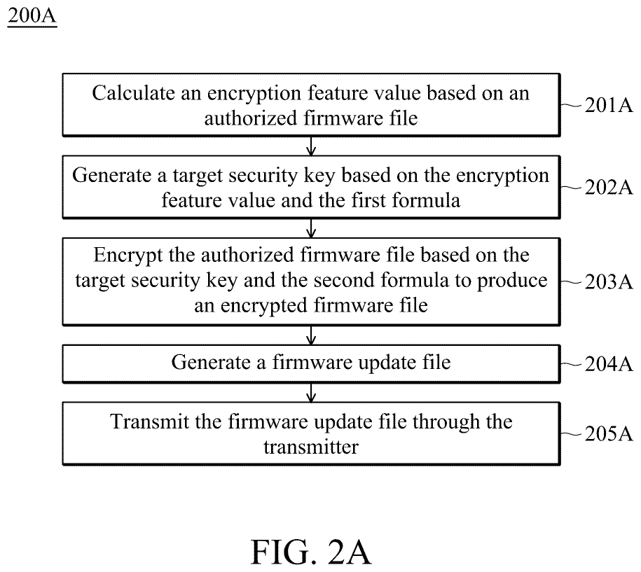

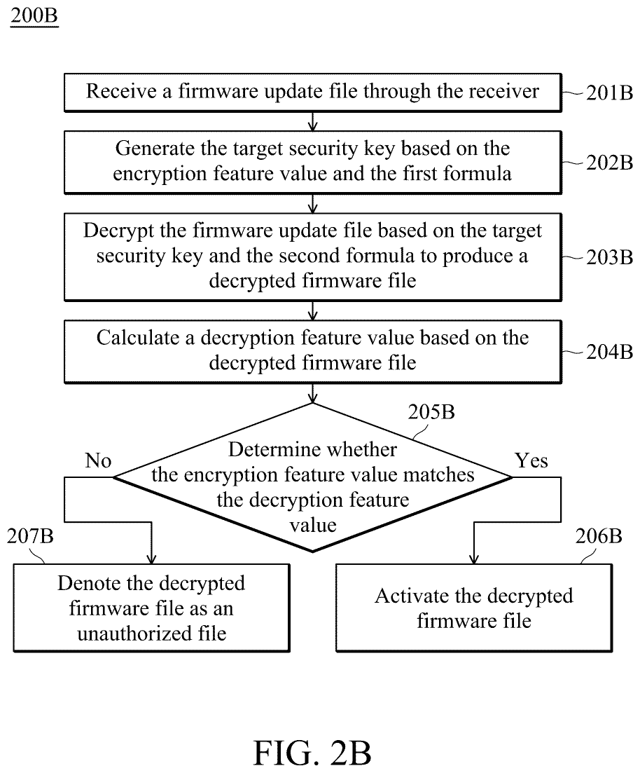

Refer to FIGS. 2A and 2B, FIGS. 2A and 2B are flow diagrams of the methods 200A and 200B for updating firmware in accordance to the embodiments of the present disclosure. Methods 200A and 200B may be implemented in the firmware update apparatus 100. Refer to FIG. 2A, method 200A starts from operation 201A. In operation 201A, the flash microcontroller 110 calculates an encryption feature value based on an authorized firmware file. In some embodiments, the encryption feature value is the cyclic redundancy check (CRC) of the authorized firmware file. In other embodiments, the encryption feature value may be the entropy of the authorized firmware file, a standard deviation of the authorized firmware file, a length of the authorized firmware file without hexadecimal “0” and “f”, or a histogram of number of “0”˜“f” of the authorized firmware file.

In operation 202A, the flash microcontroller 110 generates (e.g. calculates) a target security key based on the encryption feature value and the first formula. In some embodiments, the first formula is: y=a*x+b, wherein a and b are constants, y is the target security key, and x is the encryption feature value. However, other formulas may also be applied.

In operation 203A, the flash microcontroller 110 encrypts the authorized firmware file based on the target security key and the second formula to produce an encrypted firmware file. In some embodiments, the second formula is based on Advanced Encryption Standard (AES). In some embodiments, the second formula calculates a consequence of exclusive or (XOR). Specifically, the second formula can be expressed as:

$$for ( i = 0 ; i < size ; i ++ ) \\ Buf [ i ] = buf [ i ] \hat{} ( unsigned char ) ( ( ( key ≫ ( i \% 8 ) ) \& 0 xff ) ) ;$$

wherein buf is a part (or a section) of the authorized firmware file, size is a constant (e.g. 8), \hat{ } is bitwise XOR, unsigned char means transforming the variable into an unsigned character type variable, key is the target security key, >> is the bitwise right shift, % is the modulus (i.e. calculating the remainder), & is bitwise AND, and 0xff is the hexadecimal representation of 255, Buf[i] is the encrypted firmware file. Thus, the flash microcontroller 110 reads a section of the authorized firmware file (e.g. 8 bits) once a time and encrypts the section of the authorized firmware file using the target security key according to the second formula. Specifically, the flash microcontroller 110 calculates the consequences of the bitwise XOR between different bits of the authorized firmware file (i.e. buf[i]) and corresponding different sections of the target security key (“((key>>(i % 8)) & 0xff)” generates different sections of the target security key). Then, the flash microcontroller 110 continues to encrypt next section of the authorized firmware file. The process described above is repeated until all of the authorized firmware file has been encrypted.

In operation 204A, the flash microcontroller 110 generates a firmware update file. The firmware update file comprises the encrypted firmware file and a header. In some embodiments, the flash microcontroller 110 adds the header to the encrypted firmware file to generate the firmware update file. Specifically, the flash microcontroller 110 attaches the header to the encrypted firmware file to generate the firmware update file, so the firmware update file is a file comprising the encrypted firmware file and the header. In some embodiments, the header comprises the encryption feature value (e.g. CRC of the authorized firmware file). In some embodiments, the header further comprises the firmware information of the authorized firmware file. For example, the firmware information may be the name of the authorized firmware file, the version of the authorized firmware file, or the developer of the authorized firmware file. In operation 205A, the flash microcontroller 110 transmits the firmware update file through the transmitter 140.

Refer to FIG. 2B, method 200B starts from operation 201B. In operation 201B, the flash microcontroller 110 receives a firmware update file through the receiver 130. The received firmware update file may be stored in the flash memory 120. For example, the flash microcontroller 110 may receive the firmware update file from another firmware update apparatus 100. For example, the firmware update file may be similar to the firmware update file generated in the operation 204A and comprises a header and an encrypted firmware file.

In operation 202B, the flash microcontroller 110 generates the target security key based on the encryption feature value and the first formula. In detail, after receiving the firmware update file, the flash microcontroller 110 may obtain the encryption feature value from the header. The, the flash microcontroller 110 may calculates the target security key using the encryption feature value according to the first formula. The calculated target security key may equal to the target security key calculated in operation 202A.

In operation 203B, the flash microcontroller 110 decrypts the firmware update file based on the target security key and the second formula to produce a decrypted firmware file. In detail, the flash microcontroller 110 decrypts the encrypted firmware file in the firmware update file using the target security key calculated in the operation 202B according to the second formula to generate the decrypted firmware file. When the second formula is used for decryption, the Buf[i] may refer to the decrypted firmware file, and the buf[i] may refer to the encrypted firmware file. Thus, the flash microcontroller 110 reads a section of the encrypted firmware file (e.g. 8 bits) once a time and decrypts the section of the encrypted firmware file using the target security key according to the second formula. Specifically, the flash microcontroller 110 calculates the consequences of the bitwise XOR between different bits of the encrypted firmware file (i.e. buf[i]) and corresponding different sections of the target security key. Then, the flash microcontroller 110 continues to decrypt next section of the encrypted firmware file. The process described above is repeated until all of the encrypted firmware file has been decrypted. The encrypted firmware file may be generated through calculating the consequence of the XOR between the authorized firmware file and the target security key, and then the decrypted firmware file may be generated through calculating the consequence of the XOR between the encrypted firmware file and the same target security key. Thus, using the XOR operator to encrypt and decrypt the firmware file can simplify the encryption and decryption process and is easy to implement.

In operation 204B, the flash microcontroller 110 calculates a decryption feature value based on the decrypted firmware file. The flash microcontroller 110 calculates the decryption feature value of the decrypted firmware file. The decryption feature value has the same type with the encryption feature value. For example, when the encryption feature value is the CRC, the decryption feature value is the CRC. When the encryption feature value is the data length, the decryption feature value is the data length. The type of the encryption and decryption feature value may be preconfigured or predetermined.

In operation 205B, the flash microcontroller 110 determines whether the encryption feature value matches (e.g. equal to) the decryption feature value. When the encryption feature value matches the decryption feature value, the flash microcontroller 110 performs operation 206B. When the encryption feature value is not matched with (i.e. does not match) the decryption feature value, the flash microcontroller 110 performs operation 207B. In operation 206B, the flash microcontroller 110 activates the decrypted firmware file. If the decryption of the encrypted firmware file is successful, the decrypted firmware file will be the authorized firmware file. In operation 207B, the flash microcontroller 110 denotes the decrypted firmware file as an unauthorized file. Thus, the flash microcontroller 110 doesn't activate the decrypted firmware file.

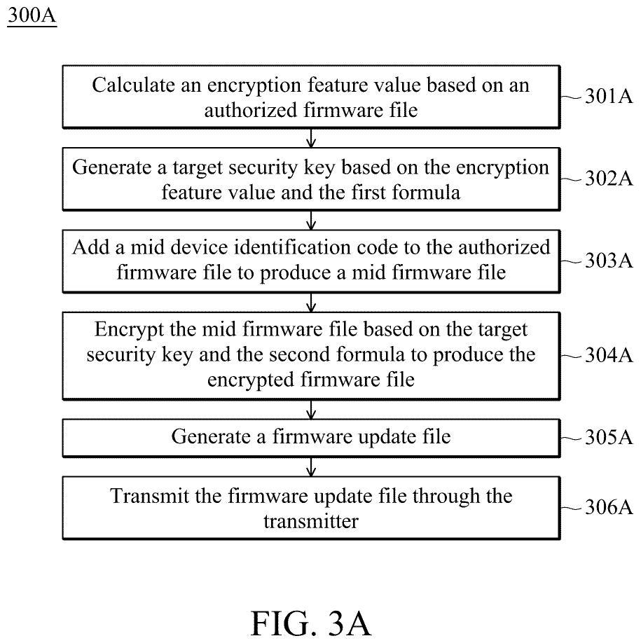

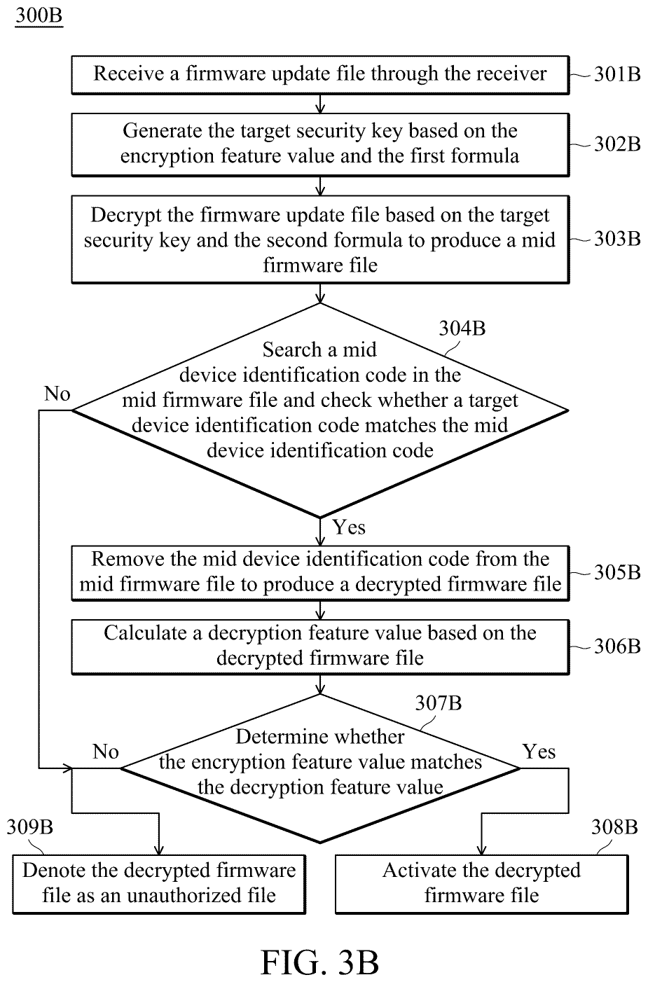

Refer to FIGS. 3A and 3B, FIGS. 3A and 3B are flow diagrams of the methods 300A and 300B for updating firmware in accordance to the embodiments of the present disclosure. Methods 300A and 300B may be implemented in the firmware update apparatus 100. Refer to FIG. 3A, method 300A starts from operation 301A. In operation 301A, the flash microcontroller 110 calculates an encryption feature value (such as CRC) based on an authorized firmware file. In operation 302A, the flash microcontroller 110 generates a target security key based on the encryption feature value and the first formula.

In operation 303A, the flash microcontroller 110 adds a mid-device identification code to the authorized firmware file to produce a mid-firmware file. Specifically, the flash microcontroller 110 attaches the mid-device identification code to the authorized firmware file to produce the mid-firmware file. Thus, the mid-firmware file comprises the mid-device identification code and the firmware file.

In operation 304A, the flash microcontroller 110 encrypts the mid-firmware file based on the target security key and the second formula to produce the encrypted firmware file. In operation 305A, the flash microcontroller 110 generates a firmware update file. The firmware update file comprises the encrypted firmware file and a header. In some embodiments, the flash microcontroller 110 adds (attaches) the header to the encrypted firmware file to generate the firmware update file. In some embodiments, the header comprises the encryption feature value (e.g. CRC of the authorized firmware file). In some embodiments, the header further comprises the firmware information of the authorized firmware file. In operation 305A, the flash microcontroller 110 transmits the firmware update file through the transmitter 140.

Refer to FIG. 3B, method 300B starts from operation 301B. In operation 301B, the flash microcontroller 110 receives a firmware update file through the receiver 130. For example, the flash microcontroller 110 may receive the firmware update file from another firmware update apparatus 100. For example, the firmware update file may be similar to the firmware update file generated in the operation 305A and comprises a header and an encrypted firmware file.

In operation 302B, the flash microcontroller 110 generates the target security key based on the encryption feature value and the first formula. In detail, the flash microcontroller 110 obtains the encryption feature value from the header and calculates the target security key using the encryption feature value according to the first formula. The calculated target security key may equal to the target security key calculated in operation 302A.

In operation 303B, the flash microcontroller 110 decrypts the firmware update file based on the target security key and the second formula to produce a mid-firmware file. In detail, the flash microcontroller 110 decrypts the encrypted firmware file in the firmware update file using the target security key calculated in the operation 302B according to the second formula to generate the mid-firmware file.

In operation 304B, the flash microcontroller 110 searches for a mid-device identification code in the mid-firmware file and checks whether the target device identification code matches the mid-device identification code. Specifically, the mid-firmware file obtained in the operation 303B may be similar to the mid-firmware file produced in the operation 303A and comprises a mid-device identification code and a firmware file (may be refer to a decrypted firmware file). Furthermore, the program memory space of the flash memory 120 may store the target device identification code. The flash microcontroller 110 obtains the mid-device identification code from the mid-firmware file and obtains the target device identification code from the flash memory 120. When the target device identification code matches the mid-device identification code, the flash microcontroller 110 performs operation 305B. When the target device identification code does not match the mid-device identification code, the flash microcontroller 110 performs operation 309B.

In operation 305B, the flash microcontroller 110 removes the mid-device identification code from the mid-firmware file to produce a decrypted firmware file. As mentioned above, the mid-firmware file may comprise the mid-device identification code and the decrypted firmware file. In operation 306B, the flash microcontroller 110 calculates a decryption feature value based on the decrypted firmware file. The flash microcontroller 110 calculates the decryption feature value of the decrypted firmware file (e.g. CRC). In operation 307B, the flash microcontroller 110 determines whether the encryption feature value matches the decryption feature value. When the encryption feature value matches the decryption feature value, the flash microcontroller 110 performs operation 308B. When the encryption feature value does not match the decryption feature value, the flash microcontroller 110 performs operation 309B. In operation 308B, the flash microcontroller 110 activates the decrypted firmware file. If the decryption of the encrypted firmware file is successful, the decrypted firmware file will be the authorized firmware file. In operation 309B, the flash microcontroller 110 denotes the decrypted firmware file as an unauthorized file. Thus, the flash microcontroller 110 doesn't activate the decrypted firmware file.

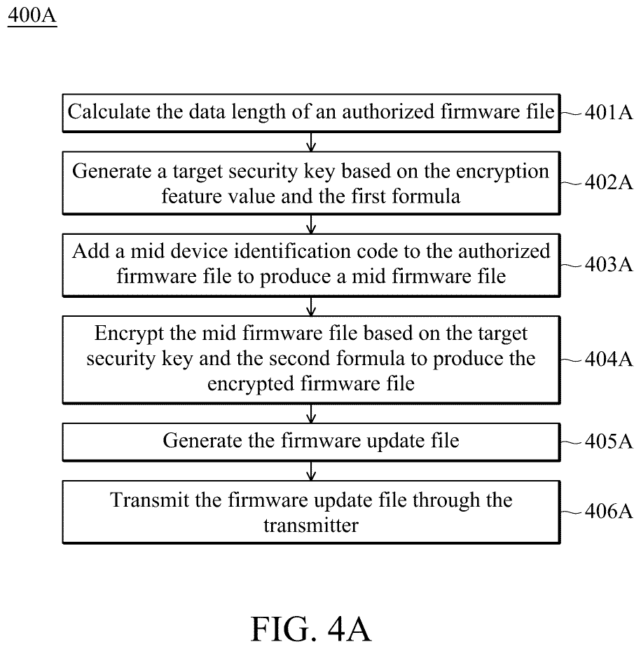

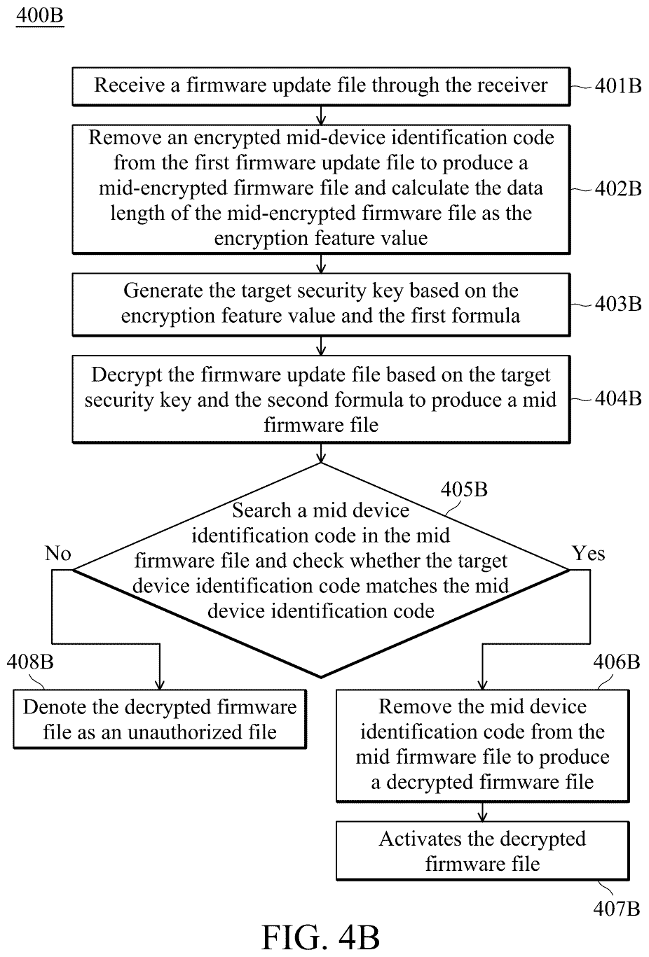

Refer to FIGS. 4A and 4B, FIGS. 4A and 4B are flow diagrams of the methods 300A and 300B for updating firmware in accordance to the embodiments of the present disclosure. Methods 400A and 400B may be implemented in the firmware update apparatus 100. In the embodiment shown in FIGS. 4A and 4B, the encryption feature value and the decryption feature value are the data length. Refer to FIG. 4A, method 400A starts from operation 401A. In operation 401A, the flash microcontroller 110 calculates the data length of an authorized firmware file. The data length is used as the encryption feature value.

In operation 402A, the flash microcontroller 110 generates a target security key based on the encryption feature value (i.e. the data length) and the first formula. In operation 403A, the flash microcontroller 110 adds a mid-device identification code to the authorized firmware file to produce a mid-firmware file. The mid-firmware file comprises the mid-device identification code and the authorized firmware file.

In operation 404A, the flash microcontroller 110 encrypts the mid-firmware file based on the target security key and the second formula to produce the encrypted firmware file. In this embodiment, the second formula will not change the data length for files after said production. In other words, the data length of the mid-firmware file is equal to the data length of the encrypted firmware file. Furthermore, the data length of the mid-device identification code is equal to the data length of the encrypted mid-device identification code. The encrypted mid-device identification code is the mid-device identification code after being encrypted based on the target security key and the second formula. Thus, the data length of the authorized firmware file is equal to the data length of the encrypted firmware file minus the data length of the encrypted mid-device identification code.

In operation 405A, the flash microcontroller 110 generates the firmware update file. Because the data length of the mid-firmware file is the same with the encrypted firmware file, it is not necessary to inform the apparatus which receives this firmware update file the encryption feature value. As a result, it is not necessary to add the header to the encrypted firmware file to generate the firmware update file. The firmware update file comprises the encrypted firmware file. In some embodiments, the firmware update file doesn't comprise the header. In operation 406A, the flash microcontroller 110 transmits the firmware update file through the transmitter 140.

Refer to FIG. 4B, method 400B starts from operation 401B. In operation 401B, the flash microcontroller 110 receives a firmware update file through the receiver 130. For example, the flash microcontroller 110 may receive the firmware update file from another firmware update apparatus 100. For example, the firmware update file may be similar to the firmware update file generated in the operation 405A and comprises an encrypted firmware file.

In operation 402B, the flash microcontroller 110 removes an encrypted mid-device identification code from the first firmware update file to produce a mid-encrypted firmware file and calculates the data length of the mid-encrypted firmware file as the encryption feature value. Specifically, the flash microcontroller 110 calculates the data length of mid-encrypted firmware file, and the data length of the encrypted firmware file is used as the encryption feature value. The encrypted mid-device identification code is the mid-device identification code after being encrypted based on the target security key and the second formula. The encrypted mid-device identification code may be at the fixed position and with fixed length. For example, the encrypted mid-device identification code may be the last 4 bits of the firmware update file. Thus, the flash microcontroller 110 is able to remove the encrypted mid-device identification code from the first firmware update file. As mentioned above, the data length of the authorized firmware file is equal to the data length of the encrypted firmware file minus the data length of the encrypted mid-device identification code. Thus, the data length of the authorized firmware file is equal to the data length of the mid-encrypted firmware file, and the data length of the mid-encrypted firmware file is used as the encryption feature value.

In operation 403B, the flash microcontroller 110 generates the target security key based on the encryption feature value and the first formula. In operation 404B, the flash microcontroller 110 decrypts the firmware update file based on the target security key and the second formula to produce a mid-firmware file. In detail, the flash microcontroller 110 decrypts the encrypted firmware file in the firmware update file using the target security key calculated in the operation 403B according to the second formula to generate the mid-firmware file. The mid-firmware file may comprise the mid-device identification code and the decrypted firmware file.

In operation 405B, the flash microcontroller 110 searches for a mid-device identification code in the mid-firmware file and checks whether the target device identification code matches the mid-device identification code. The mid-device identification code is the encrypted mid-device identification code after being decrypted based on the target security key and the second formula. When the target device identification code matches the mid-device identification code, the flash microcontroller 110 performs operation 406B. When the target device identification code does not match the mid-device identification code, the flash microcontroller 110 performs operation 408B.

In operation 406B, the flash microcontroller 110 removes the mid-device identification code from the mid-firmware file to produce a decrypted firmware file. In operation 407B, the flash microcontroller 110 activates the decrypted firmware file. If the decryption of the encrypted firmware file is successful, the decrypted firmware file will be the authorized firmware file. In operation 408B, the flash microcontroller 110 denotes the decrypted firmware file as an unauthorized file. Thus, the flash microcontroller 110 doesn't activate the decrypted firmware file.

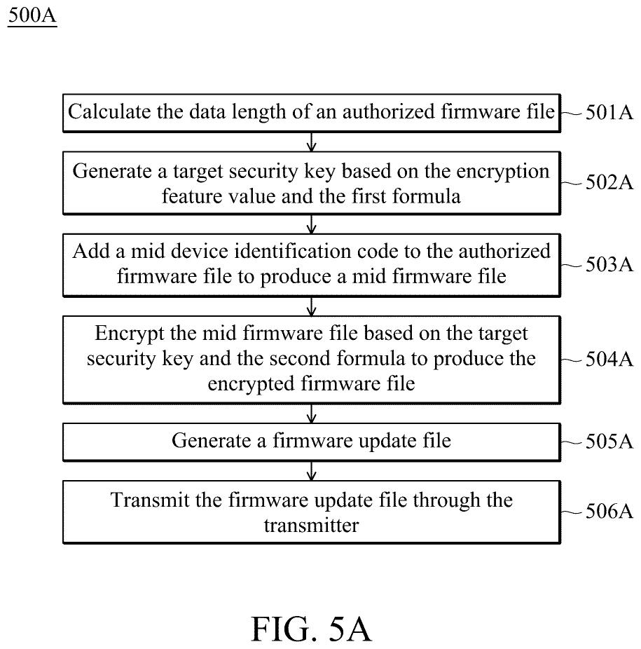

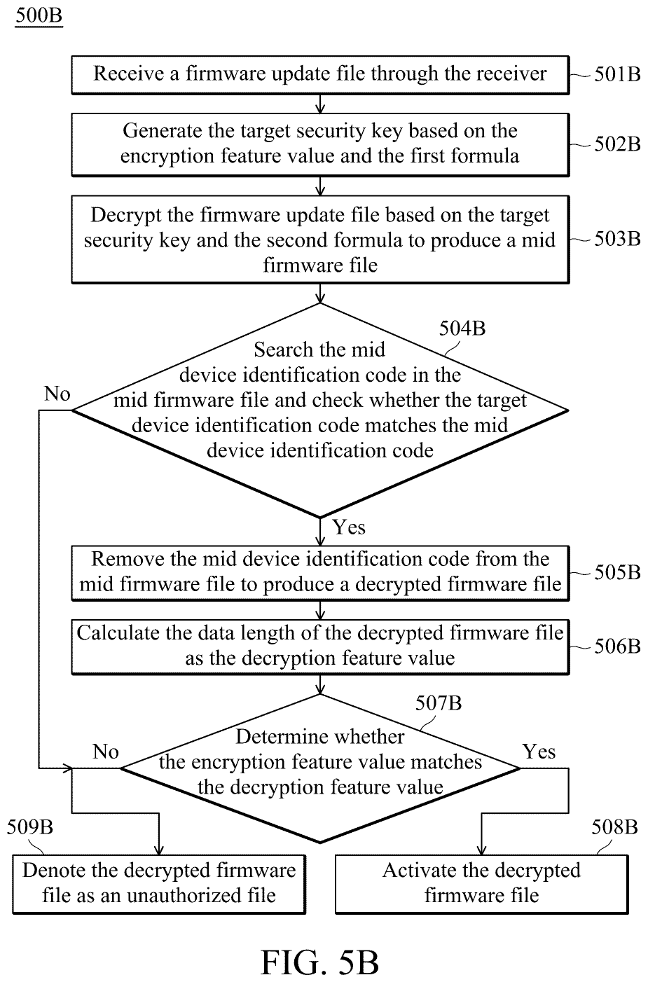

Refer to FIGS. 5A and 5B, FIGS. 5A and 5B are flow diagrams of the methods 500A and 500B for updating firmware in accordance to the embodiments of the present disclosure. Methods 500A and 500B may be implemented in the firmware update apparatus 100. Refer to FIG. 5A, method 500A starts from operation 501A. In operation 501A, the flash microcontroller 110 calculates the data length of an authorized firmware file. The data length is used as the encryption feature value. In operation 502A, the flash microcontroller 110 generates a target security key based on the encryption feature value (i.e. the data length) and the first formula.

In operation 503A, the flash microcontroller 110 adds a mid-device identification code to the authorized firmware file to produce a mid-firmware file. Specifically, the flash microcontroller 110 attaches the mid-device identification code to the authorized firmware file to produce the mid-firmware file. Thus, the mid-firmware file comprises the mid-device identification code and the firmware file.

In operation 504A, the flash microcontroller 110 encrypts the mid-firmware file based on the target security key and the second formula to produce the encrypted firmware file. In this embodiment, the second formula will change the data length for files after said production. In other words, the data length of the mid-firmware file is different from the data length of the encrypted firmware file.

In operation 505A, the flash microcontroller 110 generates a firmware update file. Because the data length will be changed after encryption, it is necessary to inform the apparatus which receives this firmware update file the encryption feature value. As a result, it is necessary to add the header to the encrypted firmware file to generate the firmware update file. The firmware update file comprises the encrypted firmware file and the header. In some embodiments, the header comprises the encryption feature value. In some embodiments, the header further comprises the firmware information of the authorized firmware file. In operation 506A, the flash microcontroller 110 transmits the firmware update file through the transmitter 140.

Refer to FIG. 5B, method 500B starts from operation 501B. In operation 501B, the flash microcontroller 110 receives a firmware update file through the receiver 130. For example, the flash microcontroller 110 may receive the firmware update file from another firmware update apparatus 100. For example, the firmware update file may be similar to the firmware update file generated in the operation 505A and comprises a header and an encrypted firmware file.

In operation 502B, the flash microcontroller 110 generates the target security key based on the encryption feature value and the first formula. In detail, the flash microcontroller 110 obtains the encryption feature value from the header and calculates the target security key using the encryption feature value according to the first formula. In operation 503B, the flash microcontroller 110 decrypts the firmware update file based on the target security key and the second formula to produce a mid-firmware file. In detail, the flash microcontroller 110 decrypts the encrypted firmware file in the firmware update file using the target security key calculated in the operation 502B according to the second formula to generate the mid-firmware file. The mid-firmware file obtained in the operation 503B may be similar to the mid-firmware file produced in the operation 503A and comprises a mid-device identification code and a firmware file (may be refer to a decrypted firmware file). In operation 504B, the flash microcontroller 110 searches for the mid-device identification code in the mid-firmware file and checks whether the target device identification code matches the mid-device identification code. When the target device identification code matches the mid-device identification code, the flash microcontroller 110 performs operation 505B. When the target device identification code does not match the mid-device identification code, the flash microcontroller 110 performs operation 509B.

In operation 505B, the flash microcontroller 110 removes the mid-device identification code from the mid-firmware file to produce a decrypted firmware file. In operation 506B, the flash microcontroller 110 calculates the data length of the decrypted firmware file as the decryption feature value. The data length of the decrypted firmware file is used as the decryption feature value. In operation 507B, the flash microcontroller 110 determines whether the encryption feature value matches the decryption feature value. In other words, the flash microcontroller 110 determines whether the data length of the authorized firmware file recorded in the header is equal to the data length of the decrypted firmware file. When the encryption feature value matches the decryption feature value, the flash microcontroller 110 performs operation 508B. When the encryption feature value does not match the decryption feature value, the flash microcontroller 110 performs operation 509B.

In operation 508B, the flash microcontroller 110 activates the decrypted firmware file. If the decryption of the encrypted firmware file is successful, the decrypted firmware file will be the authorized firmware file. In operation 509B, the flash microcontroller 110 denotes the decrypted firmware file as an unauthorized file. Thus, the flash microcontroller 110 doesn't activate the decrypted firmware file.

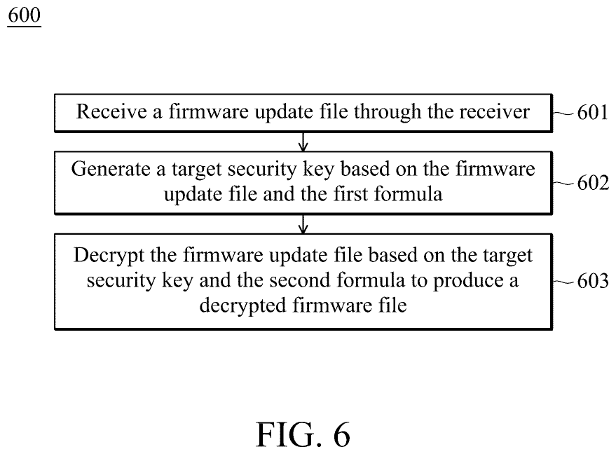

Refer to FIG. 6, FIG. 6 is a flow diagram of the method 600 for updating firmware in accordance to the embodiments of the present disclosure. Method 600 may be implemented in the firmware update apparatus 100. Refer to FIG. 6, method 600 starts from operation 601. In operation 601, the flash microcontroller 110 receives a firmware update file through the receiver 130. The firmware update file comprises an encrypted firmware file. In operation 602, the flash microcontroller 110 generates a target security key based on the firmware update file and the first formula. In operation 603, the flash microcontroller 110 decrypts the firmware update file based on the target security key and the second formula to produce a decrypted firmware file.

In some embodiments, the firmware update file comprises the encrypted firmware file and the encryption feature value. The operation of generating the target security key based on the first firmware update file and the first formula comprises: generating the target security key based on the encryption feature value using the flash microcontroller 110.

In some embodiments, method 600 further comprises: calculating the decryption feature value based on the decrypted firmware file using the flash microcontroller 110; and activating the decrypted firmware file based on a comparison result between the encryption feature value and the decryption feature value using the flash microcontroller 110.

In some embodiments, the operation of decrypting the first firmware update file based on the target security key and the second formula to produce the decrypted firmware file comprises: decrypting the encrypted firmware file of the firmware update file based on the target security key and the second formula to produce the decrypted firmware file using the flash microcontroller 110. Furthermore, method 600 further comprises: activating the decrypted firmware file when the encryption feature value matches the decryption feature value using the flash microcontroller 110.

In some embodiments, method 600 further comprises: denoting the decrypted firmware file as an unauthorized file when the encryption feature value is not matched with does not match the decryption feature value using the flash microcontroller 110.

In some embodiments, the program memory space of the flash memory 120 stores the target device identification code. The operation of decrypting the firmware update file based on the target security key and the second formula to produce the decrypted firmware file comprises using the flash microcontroller 110 to: decrypt the first firmware update file based on the target security key and the second formula to produce a mid-firmware file; search a mid-device identification code in the mid-firmware file; check whether the target device identification code matches the mid-device identification code; and remove the mid-device identification code from the mid-firmware file to produce the decrypted firmware file and activating the decrypted firmware file, when the target device identification code matches the mid-device identification code.

In some embodiments, the encryption feature value is associated with the data length of an authorized firmware file. Method 600 further comprises using the flash microcontroller 110 to: calculate the data length of the decrypted firmware file as the decryption feature value and activate the decrypted firmware file based on a comparison result between the decryption feature value and the encryption feature value.

In some embodiments, method 600 further comprises denoting the decrypted firmware file as an unauthorized file using the flash microcontroller 110, when the encryption feature value is not matched with the decryption feature value.

In some embodiments, the program memory space of the flash memory 120 stores the target device identification code. The operation of generating the target security key based on the firmware update file and the first formula comprises: removing an encrypted mid-device identification code from the first firmware update file to produce a mid-encrypted firmware file using the flash microcontroller 110; calculating a data length of the mid-encrypted firmware file as the encryption feature value using the flash microcontroller 110; and generating the target security key based on the encryption feature value using the flash microcontroller 110.

In some embodiments, the operation of decrypting the first firmware update file based on the target security key and the second formula to produce a decrypted firmware file comprises using the flash microcontroller 110 to: decrypt the first encrypted firmware file based on the target security key and the second formula to produce the mid-firmware file, wherein the second formula will not change the data length for files after said production; search the mid-device identification code in the mid-firmware file; check whether the target device identification code matches the mid-device identification code, wherein the mid-device identification code is the encrypted mid-device identification code after being decrypted based on the target security key and the second formula; remove the mid-device identification code from the mid-firmware file to produce the decrypted firmware file; and activate the decrypted firmware file, when the target device identification code matches the mid-device identification code.

In some embodiments, method 600 further comprises denoting the decrypted firmware file as an unauthorized file when the target device identification code does not match the mid-device identification code using the flash controller 110.

In some embodiments, the encryption feature value and the decryption feature value are Cyclic Redundancy Check (CRC). In some embodiments, the first formula is: y=ax+b, wherein a and b are constants, y is the target security key, and x is the encryption feature value indicated in the firmware update file. In some embodiments, the second formula is based on Advanced Encryption Standard (AES). In some embodiments, the second formula calculates a consequence of exclusive or (XOR). In some embodiments, the program memory space is divided into a bootloader section and an application section, and the target programs are executed on the bootloader section.

In some embodiments, method 600 further comprises: transmitting the firmware update file through the transmitter 140; generating the target security key based on an authorized firmware file and the first formula using the flash controller 110; encrypting the authorized firmware file based on the target security key and the second formula to produce the encrypted firmware file using the flash controller 110. The firmware update file comprises the encrypted firmware file.

In some embodiments, the firmware update file comprises the encrypted firmware file and a header with an encryption feature value. The operation of generating the target security key based on the authorized firmware file and the first formula comprises using the flash controller 110 to: calculate the encryption feature value based on the authorized firmware file; and generate the target security key based on the encryption feature value and the first formula.

In some embodiments, the operation of encrypting the authorized firmware file based on the target security key and the second formula comprises using the flash controller 110 to: add a mid-device identification code to the authorized firmware file to produce a mid-firmware file, wherein the mid-firmware file comprises the mid-device identification code and the authorized firmware file; and encrypt the mid-firmware file based on the target security key and the second formula to produce the second encrypted firmware file.

In some embodiments, the operation of generating the target security key based on the firmware file and the first formula comprises: generating the target security key based on the data length of the authorized firmware file using the flash controller 110. Method 600 further comprises using the flash controller 110 to: add a mid-device identification code to the firmware file to produce a mid-firmware file, wherein the mid-firmware file comprises the mid-device identification code and the authorized firmware file; and encrypt the mid-firmware file based on the target security key and the second formula to produce the encrypted firmware file.

In some embodiments, the data length of the authorized firmware file is equal to the data length of the encrypted firmware file, and the firmware update file doesn't include a header with the data length of the authorized firmware file.

In some embodiments, the data length of the authorized firmware file is different from a data length of the encrypted firmware file, and the firmware update file includes a header with the data length of the authorized firmware file.

Firmware update apparatus and methods for updating firmware are provided. The method of the embodiments doesn't require the firmware update apparatus to store the encryption or decryption key. Furthermore, the method of the embodiments doesn't require the firmware update file to carry the encryption or decryption key, either. Instead, the method of the embodiments allows the firmware update apparatus to calculate the key locally. The embodiments of the present disclosure also allow the firmware update apparatus to check whether the received firmware update file is authorized through comparing the feature values and the device identification codes. Thus, embodiments of the present disclosure can improve the security of the firmware update procedure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A firmware update apparatus, comprising:
a flash microcontroller,
a flash memory with a program memory space, wherein the program memory space stores a first formula and a second formula,
a receiver configured to receive a first firmware update file to be stored in the flash memory, wherein the first firmware update file comprises a first encrypted firmware file,
one or more target programs, wherein the one or more target programs are stored in the flash memory and configured to be executed by the flash microcontroller, and the one or more target programs include instructions for:
generating a target security key based on the first firmware update file and the first formula; and
decrypting the first firmware update file based on the target security key and the second formula to produce a decrypted firmware file.

2. The firmware update apparatus as claimed in claim 1, wherein the first firmware update file comprises the first encrypted firmware file and an encryption feature value;
wherein the operation of generating a target security key based on the first firmware update file and the first formula comprises:
generating the target security key based on the encryption feature value.

3. The firmware update apparatus as claimed in claim 2, wherein the one or more target programs further include instructions for:
calculating a decryption feature value based on the decrypted firmware file; and
activating the decrypted firmware file based on a comparison result between the encryption feature value and the decryption feature value.

4. The firmware update apparatus as claimed in claim 3, wherein the operation of decrypting the first firmware update file based on the target security key and the second formula to produce a decrypted firmware file comprises:
decrypting the encrypted firmware file of the first firmware update file based on the target security key and the second formula to produce the decrypted firmware file;
wherein the one or more target programs further include instructions for:
activating the decrypted firmware file when the encryption feature value matches the decryption feature value.

5. The firmware update apparatus as claimed in claim 3, wherein the one or more target programs further include instructions for denoting the decrypted firmware file as an unauthorized file when the encryption feature value is not matched with the decryption feature value.

6. The firmware update apparatus as claimed in claim 2, wherein the program memory space further stores a target device identification code, wherein the operation of decrypting the first firmware update file based on the target security key and the second formula to produce a decrypted firmware file comprises:
decrypting the first encrypted firmware file based on the target security key and the second formula to produce a first mid-firmware file;
searching a mid-device identification code in the first mid-firmware file;
checking whether the target device identification code matches the mid-device identification code; and
removing the mid-device identification code from the first mid-firmware file to produce the decrypted firmware file and activating the decrypted firmware file, when the target device identification code matches the mid-device identification code.

7. The firmware update apparatus as claimed in claim 6, wherein the encryption feature value is associated with a data length of an authorized firmware file, and the one or more target programs further include instructions for:
calculating a data length of the decrypted firmware file as the decryption feature value; and
activating the decrypted firmware file based on a comparison result between the decryption feature value and the encryption feature value.

8. The firmware update apparatus as claimed in claim 1, wherein the program memory space further stores a target device identification code, wherein the operation of generating the target security key based on the first firmware update file and the first formula further comprises:
removing an encrypted mid-device identification code from the first firmware update file to produce a mid-encrypted firmware file;
calculating a data length of the mid-encrypted firmware file as the encryption feature value; and generating the target security key based on the encryption feature value.

9. The firmware update apparatus as claimed in claim 8, wherein the operation of decrypting the first firmware update file based on the target security key and the second formula to produce a decrypted firmware file comprises:
decrypting the first encrypted firmware file based on the target security key and the second formula to produce a second mid-firmware file, wherein the second formula will not change the data length for files after said production;
searching a mid-device identification code in the second mid-firmware file, wherein the mid-device identification code is the encrypted mid-device identification code after being decrypted based on the target security key and the second formula;
checking whether the target device identification code matches the mid-device identification code; and
removing the mid-device identification code from the third mid-firmware file to produce the decrypted firmware file and activating the decrypted firmware file, when the target device identification code matches the mid-device identification code.

10. The firmware update apparatus as claimed in claim 9, wherein the one or more target programs further include instructions for denoting the decrypted firmware file as an unauthorized file when the target device identification code does not match the mid device identification code.

11. The firmware update apparatus as claimed in claim 3, wherein the encryption feature value and the decryption feature value are Cyclic Redundancy Check (CRC).

12. The firmware update apparatus as claimed in claim 2, wherein the first formula is:
y=ax+b;
wherein a and b are constants, y is the target security key, and x is the encryption feature value indicated in the first firmware update file.

13. The firmware update apparatus as claimed in claim 1, wherein the second formula is based on Advanced Encryption Standard (AES).

14. The firmware update apparatus as claimed in claim 1, wherein the second formula calculates a consequence of exclusive or (XOR).

15. The firmware update apparatus as claimed in claim 1, wherein the program memory space is divided into a bootloader section and an application section, and the one or more target programs are executed on the bootloader section.

16. The firmware update apparatus as claimed in claim 1, further comprises:
a transmitter, configured to transmit a second firmware update file, wherein the second firmware update file comprises a second encrypted firmware file,
wherein the one or more target programs include instructions for:
generating the target security key based on an authorized firmware file and the first formula; and
encrypting the authorized firmware file based on the target security key and the second formula to produce the second encrypted firmware file.

17. The firmware update apparatus as claimed in claim 16, wherein the second firmware update file comprises the second encrypted firmware file and a header with an encryption feature value;
wherein the operation of generating the target security key based on the authorized firmware file and the first formula comprises:
calculating the encryption feature value based on the authorized firmware file; and
generating the target security key based on the encryption feature value and the first formula.

18. The firmware update apparatus as claimed in claim 17, wherein the operation of encrypting the authorized firmware file based on the target security key and the second formula comprises:
adding a mid-device identification code to the authorized firmware file to produce a fourth mid-firmware file, wherein the fourth mid-firmware file comprises the mid-device identification code and the authorized firmware file; and
encrypting the fourth mid-firmware file based on the target security key and the second formula to produce the second encrypted firmware file.

19. A method for updating firmware, applicable to a firmware update apparatus, wherein the firmware update apparatus comprises a flash microcontroller and a flash memory with a program memory space, wherein the program memory space stores a first formula and a second formula, and wherein the flash memory stores one or more target programs configured to be executed by the flash microcontroller;
wherein the method comprises:
receiving, via a receiver of the firmware update apparatus, a first firmware update file to be stored in the flash memory, wherein the first firmware update file comprises an first encrypted firmware file,
generating, via the flash microcontroller, a target security key based on the first firmware update file and the first formula; and
decrypting, via the flash microcontroller, the first firmware update file based on the target security key and the second formula to produce a decrypted firmware file.

20. The method as claimed in claim 19, wherein the first firmware update file comprises the first encrypted firmware file and an encryption feature value;
wherein the operation of generating a target security key based on the first firmware update file and the first formula comprises:
generating, via the flash microcontroller, the target security key based on the encryption feature value.

21. The method as claimed in claim 20, further comprising:
calculating, via the flash microcontroller, a decryption feature value based on the decrypted firmware file; and
activating, via the flash microcontroller, the decrypted firmware file based on a comparison result between the encryption feature value and the decryption feature value.

22. The method as claimed in claim 21, wherein the operation of decrypting the first firmware update file based on the target security key and the second formula to produce a decrypted firmware file comprises:
decrypting, via the flash microcontroller, the encrypted firmware file of the first firmware update file based on the target security key and the second formula to produce the decrypted firmware file;
wherein the method further comprises:
activating, via the flash microcontroller, the decrypted firmware file when the encryption feature value matches the decryption feature value.

23. The method as claimed in claim 21, wherein the method further comprises: denoting, via the flash microcontroller, the decrypted firmware file as an unauthorized file when the encryption feature value is not matched with the decryption feature value.

24. The method as claimed in claim 20, wherein the program memory space further stores a target device identification code, wherein the operation of decrypting the first firmware update file based on the target security key and the second formula to produce a decrypted firmware file comprises:
decrypting, via the flash microcontroller, the first firmware update file based on the target security key and the second formula to produce a first mid-firmware file;
searching, via the flash microcontroller, a mid-device identification code in the first mid-firmware file;
checking, via the flash microcontroller, whether the target device identification code matches the mid-device identification code; and
removing, via the flash microcontroller, the mid-device identification code from the first mid-firmware file to produce the decrypted firmware file and activating the decrypted firmware file, when the target device identification code matches the mid-device identification code.

25. The method as claimed in claim 21, wherein the encryption feature value is associated with a data length of an authorized firmware file, and the method further comprises:
calculating, via the flash microcontroller, a data length of the decrypted firmware file as the decryption feature value; and
activating, via the flash microcontroller, the decrypted firmware file based on a comparison result between the decryption feature value and the encryption feature value.

26. The method as claimed in claim 19, wherein the program memory space further stores a target device identification code, and the operation of generating the target security key based on the first firmware update file and the first formula further comprising:
removing, via the flash microcontroller, an encrypted mid-device identification code from the first firmware update file to produce a mid-encrypted firmware file;
calculating, via the flash microcontroller, a data length of the mid-encrypted firmware file as the encryption feature value; and
generating, via the flash microcontroller, the target security key based on the encryption feature value.

27. The method as claimed in claim 26, wherein the operation of decrypting the first firmware update file based on the target security key and the second formula to produce a decrypted firmware file comprises:
decrypting, via the flash microcontroller, the first encrypted firmware file based on the target security key and the second formula to produce a second mid-firmware file, wherein the second formula will not change the data length for files after said production;
searching, via the flash microcontroller, a device identification code in the second mid-firmware file, wherein the mid-device identification code is the encrypted mid-device identification code after being decrypted based on the target security key and the second formula;
checking, via the flash microcontroller, whether the target device identification code matches the second device identification code; and
removing, via the flash microcontroller, the mid device identification code from the third mid-firmware file to produce the decrypted firmware file and activating the decrypted firmware file, when the target device identification code matches the mid-device identification code.

28. The method as claimed in claim 27, further comprising denoting the decrypted firmware file as an unauthorized file when the target device identification code does not match the mid-device identification code.

29. The method as claimed in claim 21, wherein the encryption feature value and the decryption feature value are Cyclic Redundancy Check (CRC).

30. The method as claimed in claim 21, wherein the first formula is:
y=ax+b;
wherein a and b are constants, y is the target security key, and x is the encryption feature value indicated in the first firmware update file.

31. The method as claimed in claim 19, wherein the second formula is based on Advanced Encryption Standard (AES).

32. The method as claimed in claim 19, wherein the second formula calculates a consequence of exclusive or (XOR).

33. The method as claimed in claim 19, wherein the program memory space is divided into a bootloader section and an application section, and the one or more target programs are executed on the bootloader section.

34. The method as claimed in claim 19, further comprising:
transmitting, via a transmitter of the firmware update apparatus, a second firmware update file, wherein the second firmware update file comprises a second encrypted firmware file,
generating, via the flash microcontroller, the target security key based on an authorized firmware file and the first formula;
encrypting, via the flash microcontroller, the authorized firmware file based on the target security key and the second formula to produce the second encrypted firmware file.

35. The method as claimed in claim 34, wherein the second firmware update file comprises the second encrypted firmware file and a header with an encryption feature value;
wherein the operation of generating the target security key based on the authorized firmware file and the first formula comprises:
calculating, via the flash microcontroller, the encryption feature value based on the authorized firmware file; and
generating, via the flash microcontroller, the target security key based on the encryption feature value and the first formula.

36. The method as claimed in claim 35, wherein the operation of encrypting the authorized firmware file based on the target security key and the second formula comprises:
adding, via the flash microcontroller, a mid-device identification code to the authorized firmware file to produce a fourth mid-firmware file, wherein the fourth mid-firmware file comprises the mid-device identification code and the authorized firmware file; and
encrypting, via the flash microcontroller, the fourth mid-firmware file based on the target security key and the second formula to produce the second encrypted firmware file.
